(19) United States
(12) Patent Application Publication
(10) Pub. No.: US 2021/0025029 A1
(43) Pub. Date: Jan. 28, 2021

(54) COMPOSITE POWDER AND METHODS THEREOF

(71) Applicant: AGENCY FOR SCIENCE, TECHNOLOGY AND RESEARCH, Singapore (SG)

(72) Inventors: Jin Zhao, Singapore (SG); Pei Wang, Singapore (SG); Xiaolu Song, Singapore (SG)

(73) Assignee: AGENCY FOR SCIENCE, TECHNOLOGY AND RESEARCH, Singapore (SG)

(21) Appl. No.: 15/733,665

(22) PCT Filed: Mar. 26, 2019
(86) PCT No.: PCT/SG2019/050166

§ 371 Date: Sep. 25, 2020

(30) Foreign Application Priority Data
Mar. 26, 2018 (SG) 10201802489U

(51) Int. Cl. C22C 1/04; B22F 1/02; C22C 32/00

(52) U.S. Cl. CPC C22C 1/0458; B22F 1/025; B82Y 30/00; C22C 32/0026; C22C 32/0031

(57) ABSTRACT

The present disclosure relates to composite powders and methods for forming said composite powders thereof. In particular, the present disclosure relates to composite powder comprising nanoparticles on a surface of a metal particle and methods for forming said composite powders. The present disclosure also relates to composites obtained according to methods as defined herein and a method of forming said composite.

### FIELD

The present disclosure relates to composite powders and methods for forming said composite powders thereof. In particular, the present disclosure relates to composite powder comprising nanoparticles on a surface of a metal particle and methods for forming said composite powders. The present disclosure also relates to composites obtained according to methods as defined herein and a method of forming said composite.

### BACKGROUND

Composites that combine metallic properties (ductility and toughness) with ceramic properties (high strength and high modulus) are generally known as metal matrix composites (MMCs). These composites can have greater strength in shear and compression and higher service temperature capabilities compared to the individual components. For example, physical and mechanical properties that can be obtained with MMCs include high specific modulus, strength, and thermal stability. As such, there is a constant interest in such composites in the aerospace, automotive industries. For example, these composites are used in thermal management and electronic packaging such as in radiator panels and battery sleeves, power semiconductor packages, microwave modules, black box enclosures, and printed circuit board heat sinks. The DSCS-III, a military communication satellite, uses more than 23 kg of Kovar (nickel—cobalt ferrous alloy) for microwave packaging. Replacing this metal with silicon carbide-reinforced aluminium MMC, would save more than 13 kg of weight and provide a cost savings over Kovar components.

MMCs materials consist of a reinforcement material embedded within a metal matrix phase. The reinforcement materials commonly used in MMCs include carbides (e.g. SiC, B₄C), nitrides (e.g. Si₃N₄, AlN), oxides (e.g. Al₂O₃, SiO₂), as well as elemental materials (e.g. C, Si). The reinforcements may be in the form of continuous fibres, chopped fibres, whiskers, platelets, or particulates. SiC, for example, is being used in aluminium and magnesium MMCs and carbon and silicon fibres are being used in aluminium-, magnesium-, and copper-matrix composites. Typically selection of the reinforcement material is determined by the desired property/cost combination. Generally, continuous fiber reinforced MMCs provide the highest properties in the direction of the fiber orientation. However, such MMCs are expensive. As an intermediate, chopped fiber and whisker reinforced materials can also produce good property improvements in the plane or direction of their orientation (anisotropic), but these MMCs are still expensive.

Particulates can be used as the reinforcement material in MMCs. However, many problems hinder the full-scale industrialization of MMCs such as wettability, particle distribution, porosity, and chemical reaction. These problems have explicit effects on mechanical, wear, and corrosion resistance properties of MMCs. Therefore, it is essential to provide a solution or an alternative to these problems for better quality of MMCs.

For example, the reinforcement material may not be distributed intragranular or distributed evenly and there may also be agglomerates formed within the MMCs. This can adversely affect the mechanical property of MMCs. Further, if the distribution is not controllable in the sense that its distribution is homogenous, batch to batch variations can result, causing irreproducibility in large scale manufacturing and is not desirable.

In particular, MMCs comprising nanoparticles (NPs) as the particulates have great potential for applications in advanced manufacturing due to their excellent mechanical, thermal and physical properties in comparison with pure metallic materials. The enhancement in the mechanical properties of MMCs is influenced by the size and distribution state of the reinforcement. However, it remains a challenge to be able to obtain uniform-dispersion of NPs with controlled morphology in a metal matrix due to the higher interfacial energies of NPs which favors a non-homogenous distribution in MMCs.

Accordingly, it is generally desirable to overcome or improve upon the above mentioned difficulty.

### SUMMARY OF THE INVENTION

Without wanting to be bound by theory, the inventors believe that better uniformity of the reinforcement material in MMCs can be imparted at the composite powder synthesis stage. This is in contrast to traditional methods where the reinforcement material is added separately to the metal matrix component (metal particles) during the compounding or mixing stage. The inventors have discovered that by covalently bonding the reinforcement material to the metal powder through thermally induced hydrolysis and condensation in an aqueous medium at a first temperature below sintering temperature, an intermediate composite powder can be formed. This composite powder can be subsequently subjected to a second higher sintering temperature to form a composite. The inventors believed that the strong covalent bonding prevents dislocation of the reinforcement material from the metal particle surface when subjected to high heat and/or pressure during sintering. In this sense, the reinforcement material are ‘prevented’ from aggregating when being sintered to form the composite. Additionally, the inventors have found that the reinforcement material can be stochastically positioned on the metal powder surface by forming the reinforcement material in situ with the metal particles. It is believed that by forming the nanoparticles from nanoparticle precursors, the nanoparticle precursors are able to homogenously coat or distribute around the metal particle, and when it is hydrolysed and condensed into nanoparticles are able to maintain a better uniformity or distribution (stochastic) around the metal particle surface. When the composite powder is subsequently sintered, the uniformity of reinforcement material on the metal particles can lead to better uniformity of reinforcement material in the composite; i.e the reinforcement material are well dispersed in the metal matrix with little or no aggregation or density gradient. Accordingly, when the composite powder is poured in a mold, the reinforcement material is already uniformly distributed within the mold, such that a uniform composite can be obtained when the composite powder is sintered.

In an aspect, the present invention provides a composite powder, comprising:
a) metal oxide nanoparticles; and
b) micro-size metal particles, the micro-size particles having surfaces;

wherein the metal oxide nanoparticles are covalently bonded to the surfaces of the micro-size metal particles by metal-oxygen bonds, and

wherein the metal oxide nanoparticles are stochastically positioned on the surface of the micro-size metal particles.

In an embodiment, the metal oxide nanoparticles is selected from MO, MO₂, or M₂O₃ nanoparticles.

In an embodiment, M is a tetravalent transition metal.

In an embodiment, the present invention provides a composite powder, comprising:
a) TiO₂ nanoparticles; and
b) micro-size metal particles, the micro-size particles having surfaces;

wherein the TiO₂ nanoparticles are covalently bonded to the surfaces of the micro-size metal particles by metal-oxygen bonds, and

wherein the TiO₂ nanoparticles are stochastically positioned on the surface of the micro-size metal particles.

In some embodiments, the mean particle size ratio of nanoparticles to micro-size metal particles ranges from about 1:50 to about 1:450.

In other embodiments, the weight ratio of the nanoparticles to the micro-size metal particles ranges from about 1:150 to about 1:550.

In other embodiments, the micro-size metal particles is a pure metal powder or a metal alloy powder.

In other embodiments, the micro-size metal particles is selected from the group consisting of Ni powder, Inconel 625 powder or Ti powder.

In other embodiments, the nanoparticles are TiO₂ nanoparticles having a phase structure of about 50% to about 60% anatase phase and about 40% to about 50% brookite phase.

In other embodiments, the nanoparticles have a mean particle size of about 100 nm to about 400 nm.

In other embodiments, the micro-size metal particles has a mean particle size of about 10 μm to about 80 μm.

In another aspect, the present invention provides a method of forming a composite powder, the composite powder comprising metal oxide nanoparticles and micro-size metal particles, the micro-size particles having surfaces, the method including the steps of:
a) covalently bonding the metal oxide nanoparticles to surfaces of the micro-size metal particles by metal-oxygen bonds; and
b) stochastically positioning the metal oxide nanoparticles on the surfaces of the micro-size metal particles to form the composite powder.

In some embodiments, the covalently bonding step (step (a)) comprises condensing the nanoparticles on the surfaces of the micro-size metal particles to form the metal-oxygen bonds. This step can be performed at a first temperature, which is below a sintering temperature.

In other embodiments, the method further includes a step of mixing a nanoparticle precursor with the micro-size metal particles in an aqueous solvent to form a mixture prior to step (a).

In other embodiments, the method further includes a step of heating the mixture at a first temperature for a time and under conditions to convert the nanoparticle precursor to nanoparticles after the mixing step.

In other embodiments, the heating step comprises hydrolysing and condensing the nanoparticle precursor in the presence of the aqueous solvent to form the nanoparticles. The first temperature is below a sintering temperature, and is for inducing hydrolysis and condensation of the nanoparticle precursor to form nanoparticles.

In other embodiments, the nanoparticle is TiO₂ nanoparticle and the nanoparticle precursor is Ti(IV) alkoxide.

In other embodiments, the nanoparticle is TiO₂ nanoparticle and nanoparticle precursor is selected from the group consisting of titanium(IV) isopropoxide (TIP), titanium (IV) ethoxide, titianium(IV) butoxide, titanium(IV) propoxide and titanium(IV) tert-butoxide.

In other embodiments, the aqueous solvent comprises a water-miscible organic solvent.

In other embodiments, the water-miscible organic solvent is selected from the group consisting of acetonitrile, tetrahydrofuran, acetone, ethylacetate and dichloromethane.

In other embodiments, the weight ratio of the nanoparticle precursor to micro-size metal powder is about 1:40 to about 1:120.

In other embodiments, the time and condition is heating under reflux for at least 30 min.

In other embodiments, the method further includes a step of purifying the composite powder after step (b).

In other embodiments, the purifying step comprises separating nanoparticles uncoupled (not bound) to the surface of the micro-size metal powder from the composite powder.

In another aspect, the present invention provides a composite, comprising:
a) MO₂ nanoparticles; and
b) a metal matrix selected from Ni, Inconel 625 or Ti;

wherein the MO₂ nanoparticles are coupled to the metal matrix by metal-oxygen bonds, and

wherein the MO₂ nanoparticles are stochastically positioned within the metal matrix.

### BRIEF DESCRIPTION OF THE DRAWINGS

Some embodiments of the present invention are herein described by way of non-limiting example only, with reference to the accompanying drawings in which:

FIG. 1 is a schematic representation of the method of forming a composite powder (steps i-iii) and forming a composite (step iv).

FIG. 2 is a X-ray powder diffraction (XRD) plot of TiO₂ nanoparticles (Ti-1).

FIG. 3 illustrates scanning electron microscope (SEM) image of Ti-1.

FIG. 4 are XRD plots of TiO₂ nanoparticles obtained from reactions between CH₃CN and titanium(IV) isopropoxide (TIP) with water when TIP is 1 mL and CH₃CN is 5 mL (TIP+CH₃CN(5)); CH₃CN is 10 mL (TIP+CH₃CN(10)); CH₃CN is 15 mL (TIP+CH₃CN(15)) and CH₃CN is 20 mL (TIP+CH₃CN(20)).

FIG. 5 illustrates SEM images of TiO₂ nanoparticles obtained from the same reaction conditions of FIG. 4.

FIG. 6 illustrates SEM images of Ti and TiO₂/Ti obtained from a reaction when TIP is 1 mL, CH₃CN is 5 mL and H₂O is 25 mL.

FIG. 7 illustrates an SEM image of Inconel 625 (IN625) powder.

FIG. 8 illustrates SEM images of TiO₂/Inconel 625 (IN625) composite powder obtained from reactions when TIP is 1 mL, IN625 is lg and CH₃CN is 5 mL, 10 ml or 15 mL in the presence of water.

FIG. 9 illustrates SEM image of TiO₂/Inconel 625 (IN625) composite powders 1-4.

FIG. 10 illustrates the porosity of composites 1-4 formed from sintering composite powder 1-4 respectively under nano-indentation tests.

FIG. 11 illustrates the hardness of composites 1-4 formed from sintering composite powder 1-4 respectively and IN625 specimen (comparator) under nano-indentation tests.

### DETAILED DESCRIPTION

As used herein, ‘metal matrix composite’ refers to a composite material with at least two parts, one part being a metal matrix, and the other part (material) which may be a different metal or another material, such as a ceramic or organic compound. The other part that is incorporated can be also a reinforcing material, which can be fibres or particles. As used herein, the reinforcement material is a particulate, and in particular, nanoparticles.

As used herein, ‘nanoparticles’ refer to particles with a particle size of more than 0.1 nanometres (nm) and less than 1000 nm. The nanoparticles can be of any shape, but preferentially spherical. Nanoparticles can exhibit size-related properties significantly different from those of either fine particles (micro-size or larger) or bulk materials. For example, the properties of TiO₂ nanoparticles to block UV radiation while remaining transparent are different from those of fine TiO₂ particles (micro-size or larger) or bulk TiO₂ which appears white in color and have almost no UV absorption.

As used herein, ‘metal oxide’ refers to a chemical compound that contains at least one oxygen atom and at least one other element in its chemical formula, the metal selected from Group 1 to 12 of the periodic table, including alkali metal, alkaline earth metal and transition metals. The element can also be selected from Group 13, for example Aluminium, Gallium, Indium, Thallium, Nihonium, or from Group 14, for example Germanium, Tin, Lead or Flerovium. “Oxide” itself is the dianion of oxygen, an 0′ atom. Metal oxides thus typically contain an anion of oxygen in the oxidation state of −2. As used herein, the metal oxide refers to MO, MO₂, or M₂O₃ with the metal element in the +2, +3 or +4 oxidation state.

Traditionally, composites and in particular metal matrix composites (MMCs) may be fabricated by several methods. For example, the reinforcing material can be directly mixed or compounded into either a molten liquid metal or with a powder metal and subsequently cured to form the MMC. When liquid metal is used, the process is known as stir casting. Another method is high energy ball milling which utilizes the high energy impact and high frequency from balls to repeatedly forge metal powder and reinforcing material by repeated deformation, rewelding, fragmentation of premixed powders to blend the components together. Another method is to use ultrasonic probe to assist in dispersing the reinforcing material into the metal matrix. As mentioned above, these methods are not able to reasonably solve the problems of the art such as irregular distribution of reinforcing material and/or agglomerates formed within the MMCs as well as batch to batch variations in large scale manufacturing.

To solve at least a problem of the art, the inventors developed a composite powder, which can be subsequently used to form the composite, by for example sintering the composite powder. The composite powder, comprises:
a) metal oxide nanoparticles; and
b) micro-size metal particles, the micro-size particles having surfaces;

wherein the metal oxide nanoparticles are covalently bonded to the surfaces of the micro-size metal particles by metal-oxygen bonds, and

wherein the metal oxide nanoparticles are stochastically positioned on the surface of the micro-size metal particles.

In some embodiments, M is a divalent, trivalent or tetravalent metal. The valency of an element is a measure of its combining power with other atoms when it forms chemical entities. In other words, the valency is the maximum number of univalent atoms (for example hydrogen or chlorine atoms) that may combine with an atom of the element under consideration, or with a fragment, or for which an atom of this element can be substituted. The valency only describes connectivity and not the geometry of the entity. For example, a tetravalent metal is able to form four bonds with four univalent atoms. In some embodiments, M is a tetravalent metal. In another embodiment, M is a tetravalent transition metal. Examples of M are, but not limited to Ti, Zr, Sn, Ge and Ce.

In an embodiment, the metal oxide nanoparticles is selected from MO, MO₂, or M₂O₃ nanoparticles. In some embodiments, the metal oxide nanoparticles is MO₂ nanoparticles. The skilled person would understand, as will also be described below, that MO, MO₂ or M₂O₃ nanoparticle precursors (i.e. M is divalent, trivalent or tetravalent) can undergo the similar hydrolysis and condensation reactions, such that these nanoparticles can be stochastically distributed and covalently attached to the surface of the metal particles.

Accordingly, in some embodiments, the present invention provides a composite powder, comprising:
a) MO₂ nanoparticles, wherein M is a tetravalent metal; and
b) micro-size metal particles, the micro-size particles having surfaces;

wherein the MO₂ nanoparticles are covalently bonded to the surfaces of the micro-size metal particles by metal-oxygen bonds, and

wherein the MO₂ nanoparticles are stochastically positioned on the surface of the micro-size metal particles.

In a preferred embodiment, the composite powder comprises:
a) TiO₂ nanoparticles; and
b) micro-size metal particles, the micro-size particles having surfaces;

wherein the TiO₂ nanoparticles are coupled to the surfaces of the micro-size metal particles by metal-oxygen bonds, and

wherein the TiO₂ nanoparticles are stochastically positioned on the surface of the micro-size metal particles.

As used herein, the ‘composite powder’ is a powder in which each particle consists of two or more distinct materials joined together. In this regard, the powder refers to a multitude to particles, the particles being of micro-sized. Composite powder differs from the ‘composite’ in that the composite is the end product after subjecting the composite powder to further processing. For example, the composite powder can be sintered to form the composite.

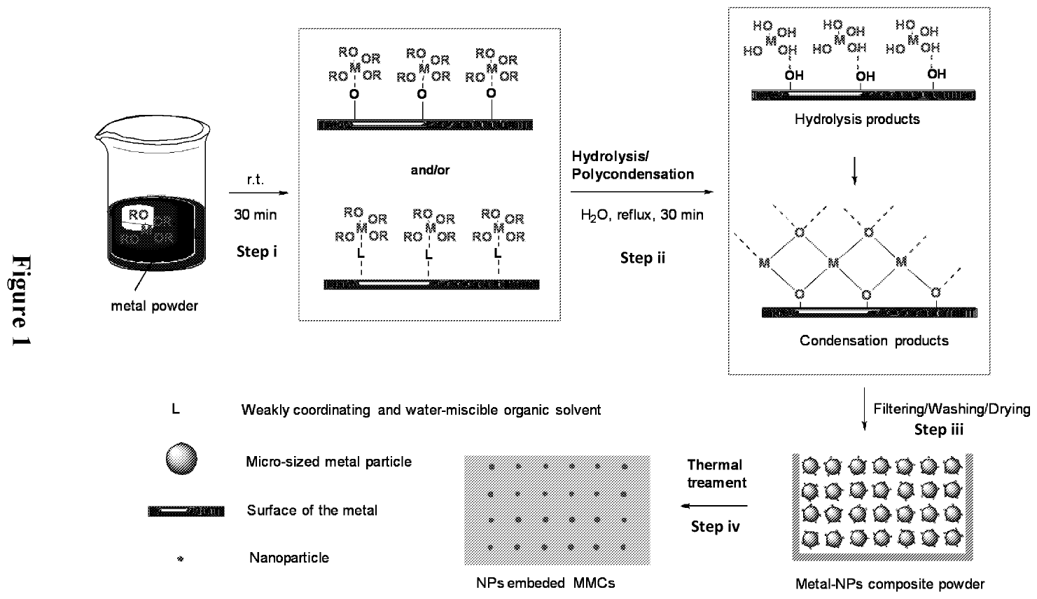

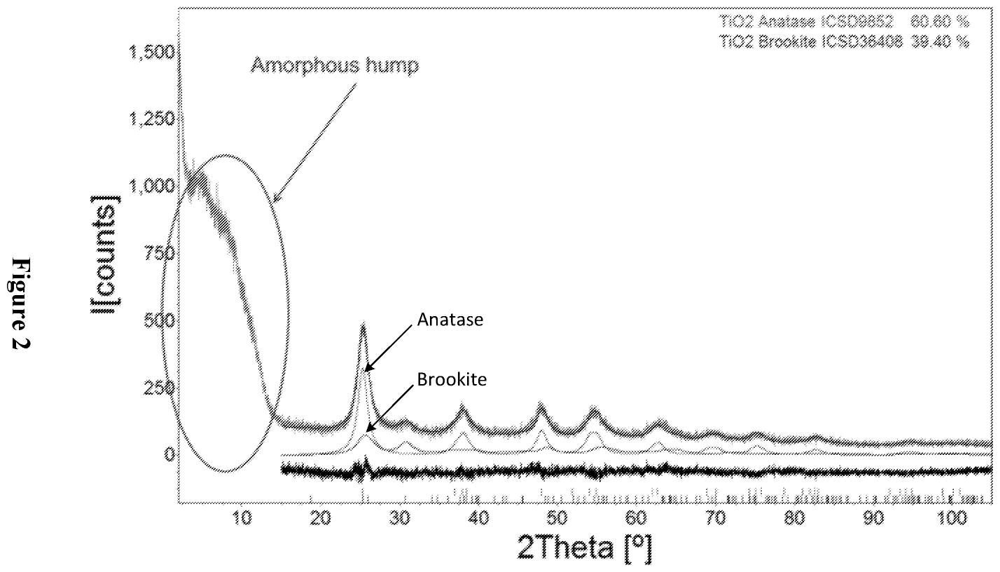

The nanoparticles (NPs) formed is coupled to surfaces of the metal particles. The coupling is preferably by metal-oxygen bonding; i.e. covalent bonding. In this regard, the NPs is attached strongly and directly to the metal powder. This is effected by a condensation reaction, wherein the hydroxyl groups on the metal particle surface and the TiO₂ NP (for example) reacts to form a metal-O—Ti bond with the elimination of a H₂O molecule (FIG. 1). For example, if the metal powder is Ni powder and the nanoparticle is TiO_{2,} a Ni—O—Ti bond may be formed to directly couple the NP to the metal particle surface. The metal-oxygen bond can be probed by techniques known in the art, for example X-ray absorption near edge structure (XANES) spectroscopy, X-ray photoelectron spectroscopy or mass spectroscopy. The metal-oxygen bond can have a binding energy of about 454 eV to about 459 eV (Ti—O) or about 853 eV to about 867 eV (Ni—O). In an embodiment, the nanoparticles are attached to the metal powder surface via covalent bonds.

The inventors have found that by utilising the surface functionalities of the metal particles (i.e. —OH groups), the distribution of nanoparticles on the surfaces can be controlled. Ligands and/or coordinating agents can be further used to facilitate the complexation of nanoparticle precursors (as will be described herein) to the metal particle surfaces, hereby forming a single layer corona of nanoparticle precursor on the metal powder surfaces. When subjected to favourable conditions, the nanoparticle precursor can be hydrolysed and condensed to form nanoparticle seeds and subsequently nanoparticles. The nanoparticles then condense and couple to the surfaces of metal particles, and may further grow into larger nanoparticles. In this way, the formation and growth of nanoparticles in situ and on the surfaces of metal particle favors a localised and dispersed distribution of NPs on the surfaces of metal particles, allowing for aggregation to be avoided which is undesirable.

This is desirable for forming the composite. For example, sintering can be used to convert the composite powder to a composite product. As high temperatures and pressure are often used during these formation process, weaker bonds such as physical bonds or electrostatic interactions may not be ideal as it would mean that the NPs can dissociate or break free from the metal powder surface. This can be disadvantageous as aggregation of NPs may subsequently result.

The metal oxide nanoparticles are stochastically positioned on the surface of the micro-size metal particles. As used herein, ‘stochastic’ refers to having a random probability distribution. Due to this random placement of the NPs on the surface, a uniform distribution of NPs on the surfaces of the metal particles can be obtained. This is advantageous for forming a composite with an even distribution of NPs within the composite, resulting in a composite with better uniformity.

For the NPs to be further evenly distributed within the resultant composite, the mean particle size ratio of the NPs to metal particles can be controlled to be within a certain range. If the metal particles are too large or small, it was found that an even distribution of NPs within the composite cannot be favourably obtained. For example, if the metal particles are too large, the NPs will be spaced apart by at least the diameter of the metal particles, which translates to areas within the composite which are void of NPs. If the metal particles are too small, some areas within the composite may have high concentrations of NPs. Accordingly, in some embodiments, the mean particle size ratio of metal oxide nanoparticles to micro-size metal particles ranges from about 1:50 to about 1:450. In other embodiments, the mean particle size ratio ranges from about 1:55 to about 1:440, about 1:60 to about 1:430, about 1:70 to about 1:420, about 1:80 to about 1:410, about 1:90 to about 1:400, about 1:100 to about 1:400, about 1:150 to about 1:400, about 1:200 to about 1:400, about 1:250 to about 1:400 or about 1:300 to about 1:400. In other embodiments, the mean particle size ratio is about 1:50, about 1:55, about 1:60, about 1:70, about 1:80, about 1:90, about 1:100, about 1:150, about 1:200, about 1:250, about 1:300, about 1:350, about 1:400, about 1:410, about 1:420, about 1:430, about 1:440 or about 1:450.

Advantageously, when the mean particle sizes of the metal powder and NPs are within this ratio, a favourable surface energy is obtainable such that the composite powder is stable and will not tend to aggregate or agglomerate. This is favourable as the composite powder can maintain a good flowability for large scale manufacturing. Further, the mean particle size ratio provides that changes in the composite powder particle size is minimised, and accordingly, the variance in composite powder particle size is not altered significantly. In this regard, this will ensure that processibility can be streamlined in a manufacturing plant. For example, when a composite with a different NP content is required, no or little manual work/alteration is required to re-calibrate the machines.

The inventors have found also that this uniform distribution can be further controlled by the concentration (and/or weight ratio) of the NPs and metal particles. In this regard, the NPs can be incorporated or doped onto the metal particles surfaces so as not to completely saturate the surfaces. This allows the NPs in the composite powder to still retain its distinct particulate nature when formed into the composite.

In some embodiments, the weight percent of metal oxide nanoparticles in the composite is about 0.18% to about 0.7%. In other embodiments, the weight percent of metal oxide nanoparticles in the composite is about 0.25% to about 0.5%. Accordingly, in some embodiments, the weight ratio of the metal oxide nanoparticles to the micro-size metal particles ranges from about 1:150 to about 1:550. In other embodiments, the weight ratio is about 1:160 to about 1:500, about 1:170 to about 1:490, about 1:180 to about 1:480, about 1:190 to about 1:470, about 1:190 to about 1:460, about 1:190 to about 1:450, about 1:190 to about 1:440, about 1:190 to about 1:430, about 1:190 to about 1:420, about 1:190 to about 1:410 or about 1:190 to about 1:400. In other embodiments, the weight ratio is about 1:150, about 1:160, about 1:170, about 1:180, about 1:190, about 1:200, about 1:220, about 1:240, about 1:260, about 1:280, about 1:300, about 1:320, about 1:340, about 1:360, about 1:380, about 1:400, about 1:410, about 1:420, about 1:430, about 1:440, about 1:450, about 1:460, about 1:470, about 1:480, about 1:490, about 1:500 or about 1:550.

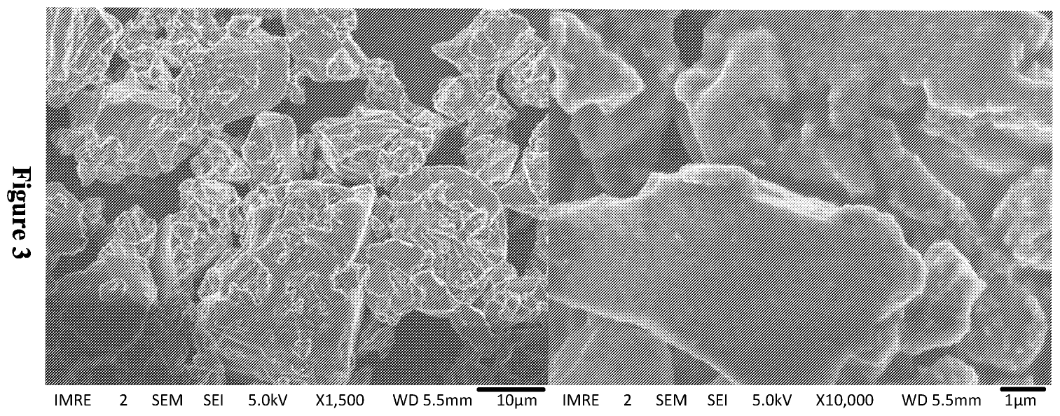

When TiO₂ NPs are used, the TiO₂ NPs have a phase structure of about 50% to about 60% anatase phase and about 40% to about 50% Brookite phase. This is reflected in FIGS. 2 and 4.

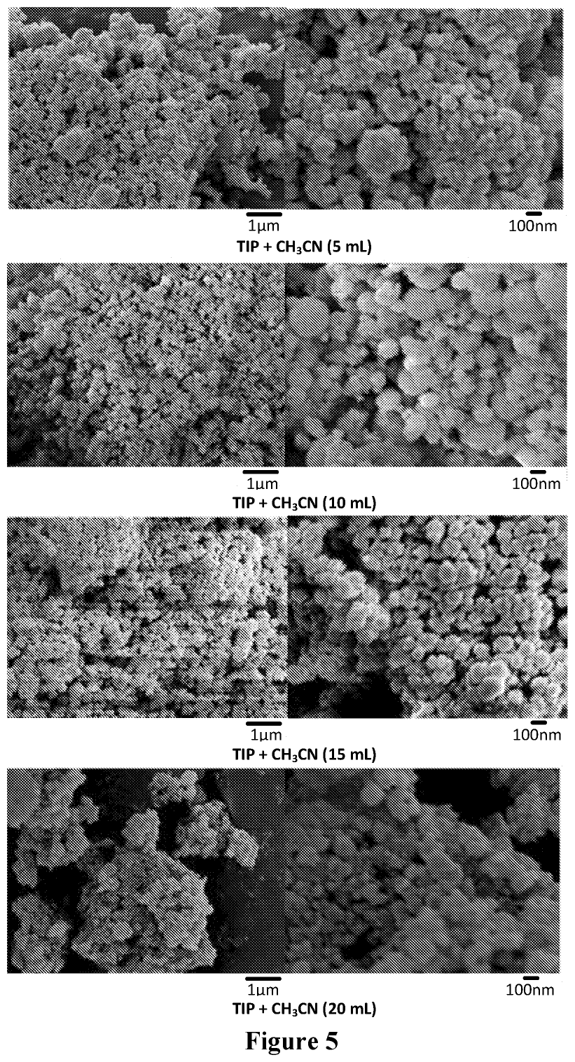

The nanoparticles formed have controlled morphology. In this regard, the size and shape of the nanoparticles formed may be controlled. The NPs formed are spherical as shown in FIG. 5.

Accordingly, in an embodiment, the nanoparticles formed are mostly substantially spherical. In another embodiment, the nanoparticles are mostly substantially elliptical. In another embodiment, the nanoparticle formed has a mean diameter or mean particle size of about 20 nm to about 950 nm. Alternatively, the NPs can have a mean particle size of about 100 nm to about 400 nm. Preferably, the mean particle size is of about 100 nm to about 350 nm, about 100 nm to about 300 nm, about 100 nm to about 250 nm or about 100 nm to about 200 nm.

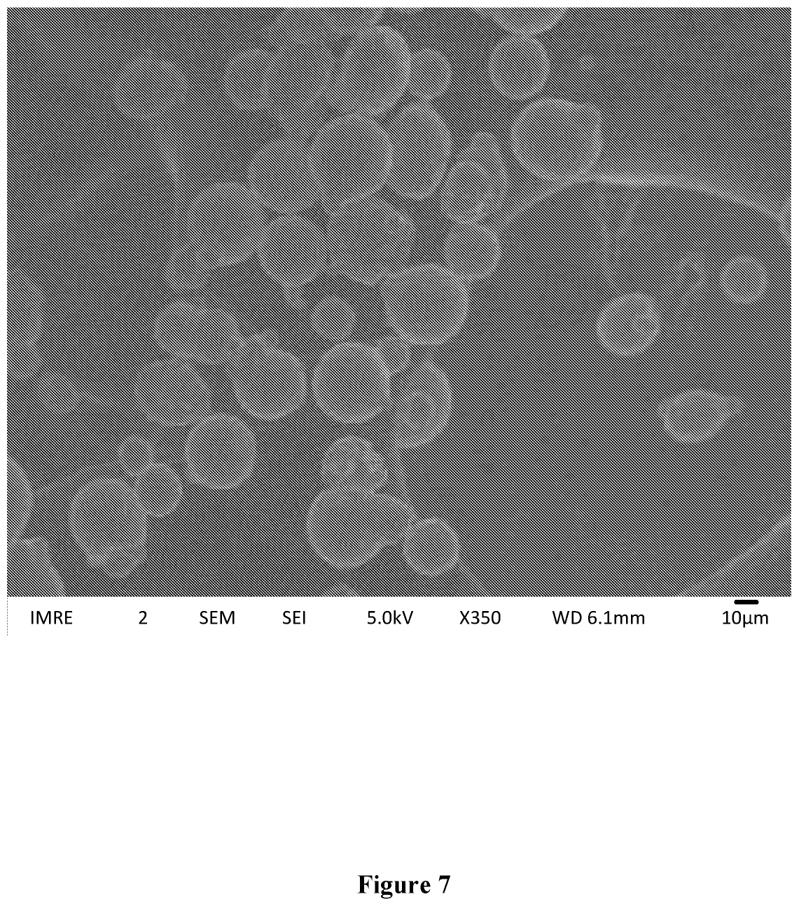

The metal particles are preferably micro sized. The metal particles may be a pure metal powder or a metal alloy powder. For example, Ni powder, Inconel 625 powder (IN625) or Ti powder may be used. IN625 is a nickel chromium molybdenum alloy and is readily available from specialty metal sources such Special Metals or ASM Aerospace Metals. An example is shown in FIG. 7. These metal particles can have a mean particle size of about 10 μm to about 80 μm. Preferably, the mean particle size of the metal powder is about 10 μm to about 60 μm, about 10 μm to about 50 μm, or about 15 μm to about 45 μm. As disclosed herein, selection of the particle size of the metal particles can be beneficial to the distribution of the NPs on the metal particle surfaces.

While IN625 has been exemplified, the skilled person would know that other metal particles can be used. Accordingly, in another embodiment, metal particles (and hence metal powders) can be selected from, but not limited to, Al powder, Al alloy powder, Ni powder, Ni alloy powder, Fe powder, Fe alloy powder, Ti powder, Ti alloy powder, Cu powder, Cu alloy powder, Co powder, Co alloy powder, Zn powder and Zn alloy powder.

In another aspect, the present invention provides a method of forming a composite powder, the composite powder comprising metal oxide nanoparticles and micro-size metal particles, the micro-size particles having surfaces, the method including the steps of:
a) covalently bonding the metal oxide nanoparticles to surfaces of the micro-size metal particles by metal-oxygen bonds; and
b) stochastically positioning the metal oxide nanoparticles on the surfaces of the micro-size metal particles to form the composite powder.

In some embodiments, the present invention provides a method of forming a composite powder, the composite powder comprising MO₂ nanoparticles and micro-size metal particles, the micro-size particles having surfaces, the method including the steps of:
a) covalently bonding the MO₂ nanoparticles to surfaces of the micro-size metal particles by metal-oxygen bonds; and
b) stochastically positioning the MO₂ nanoparticles on the surfaces of the micro-size metal particles to form the composite powder.

As mentioned above, and as shown in FIG. 1, the coupling of NPs to the metal particles is by covalent bonding, and in particular metal-oxygen bonds. This is effected by a condensation reaction, wherein the hydroxyl groups on the metal particle surface and the metal oxide NP reacts to form a metal-O-M bond with the elimination of a H₂O molecule. Advantageously, the formation of a strong bond allows for a stochastic distribution of NPs on the surfaces and also prevents dissociation of the NPs from the metal particle surfaces when forming the composite. It is believed that the stochastic distribution is influenced by numerous factors, such as the availability of surface area of the metal particles, the passivation of the ligand on the surface of the metal particles, and/or the surface energy of the forming NPs.

Accordingly, in an embodiment, the coupling comprises condensing the metal oxide nanoparticles on the surfaces of the micro-size metal particles to form the metal-oxygen bonds. In another embodiment, the nanoparticles are coupled to the metal powder surface via covalent bonds. In another embodiment, the nanoparticles are attached to the metal powder surface via a condensation process.

In this regard, in an embodiment, the method of forming a composite powder includes the steps of:
a) covalently bonding the metal oxide nanoparticles to surfaces of the micro-size metal particles by metal-oxygen bonds via a condensation process; and
b) stochastically positioning the metal oxide nanoparticles on the surfaces of the micro-size metal particles to form the composite powder;

wherein the covalently bonding step is performed at a first temperature.

In an embodiment, the method of forming a composite powder includes the steps of:
a) covalently bonding the MO₂ nanoparticles to surfaces of the micro-size metal particles by metal-oxygen bonds via a condensation process; and
b) stochastically positioning the MO₂ nanoparticles on the surfaces of the micro-size metal particles to form the composite powder;

wherein the covalently bonding step is performed at a first temperature.

This step can be performed at a first temperature, which is below a sintering temperature. For example, the temperature can be at about 100° C. if water is the solvent. Alternatively, the mixture can be refluxed at the solvent's boiling point.

The method can further include a step of mixing a nanoparticle precursor with the micro-size metal particles in an aqueous solvent to form a mixture prior to step (a).

As used herein, “precursor” refers to a substance from which another is formed. In this regard, a “nanoparticle precursor” is a substance or entity which can be transformed into a nanoparticle. Such nanoparticle precursor is usually in a metal/inorganic complex configuration, and is usually converted to the nanoparticle via a chemical reaction. It would be clear to the skilled person that at least one precursor is needed to form a nanoparticle, and that any nanoparticle precursor used in a bottom-up approach of nanoparticle synthesis may be used. For example, to make Au nanoparticles, tetrachloroauric acid as a precursor may be used. Alternatively, to make Janus nanoparticles or bimetallic nanoparticles, at least two precursors will be needed.

Accordingly, in an embodiment, the method of forming a composite powder includes the steps of:
ai) mixing a nanoparticle precursor with the micro-size metal particles in an aqueous solvent to form a mixture;
a) covalently bonding the metal oxide nanoparticles to surfaces of the micro-size metal particles by metal-oxygen bonds via a condensation process; and
b) stochastically positioning the metal oxide nanoparticles on the surfaces of the micro-size metal particles to form the composite powder;

wherein the covalently bonding step is performed at a first temperature.

In an embodiment, the method of forming a composite powder includes the steps of:
ai) mixing a nanoparticle precursor with the micro-size metal particles in an aqueous solvent to form a mixture;
a) covalently bonding the MO₂ nanoparticles to surfaces of the micro-size metal particles by metal-oxygen bonds via a condensation process; and
b) stochastically positioning the MO₂ nanoparticles on the surfaces of the micro-size metal particles to form the composite powder;

wherein the covalently bonding step is performed at a first temperature.

In some embodiments, the nanoparticle precursor is a transition metal alkoxide. Examples of nanoparticle precursors are, but not limited to, Ti(IV) alkoxide, zirconium(IV) alkoxide, tin(IV) alkoxide, germanium(IV) alkoxide and cerium(IV) alkoxide. In a preferred embodiment, the nanoparticle precursor is Ti(IV) alkoxide. As used herein, an ‘alkoxide’ is the conjugate base of an alcohol and therefore consists of an organic group bonded to a negatively charged oxygen atom. They may be written as RO—, where R is the organic substituent. Examples of Ti(IV) alkoxide are, but not limited to, titanium (IV) isopropoxide, titanium (IV) ethoxide, titianium(IV) butoxide, titanium(IV) propoxide and titanium(IV) tert-butoxide. In a preferred embodiment, the nanoparticle precursor is titanium (IV) isopropoxide (TIP). Advantageously, the use of a nanoparticle precursor enhances its affinity towards micro-size metal particle surfaces via electrostatic interaction. This is desirable for achieving uniform dispersion of NPs with controlled morphology on the metal powder surface. It is further advantageous to use a nanoparticle alkoxide precursor as these precursors have a high reactivity in water, thus allowing the formation and coupling of the nanoparticles to the metal particles at the first temperature. In this regard, the nanoparticle precursor is able to undergo a dehydration reaction to form the NPs.

Other examples of nanoparticle precursor can be metal carboxylates (COO⁻) and metal chlorides. Metal chlorides can also be used at the presence of an alcohol or a carboxylic acid.

As used herein, “solvent” refers to a substance that is able to dissolve, contain or disperse other substances. In some cases, “solvent” is a substance in a liquid phase. Solvents can be either polar or non-polar, and/or either protic or aprotic. Also included within this definition is mixture of solvents. Such mixtures of solvents refer to combinations of solvents which may or may not result in a final single phase. ‘Solvents’ and ‘solvent mixtures’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water.

As used herein, ‘aqueous solvent’ refers to a water based solvent or solvent systems that comprises mainly water and can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also fall within this definition.

In some embodiments, the aqueous solvent is water. In this regard, the aqueous solvent comprises at least about 70% water, at least about 80% water, or at least about 90% water.

Other water miscible solvent may also be included. Such water-miscible organic solvent can include, and is not limited to, acetaldehyde, acetic acid, acetone, acetonitrile, 1,2-Butanediol, 1,3-Butanediol, 1,4-Butanediol, 2-Butoxyethanol, butyric acid, diethanolamine, diethylenetriamine, dimethylformamide, dimethoxyethane, dimethyl sulfoxide, 1,4-Dioxane, ethanol, ethylamine, ethylene glycol, formic acid, furfuryl alcohol, glycerol, methanol, methyl diethanolamine, methyl isocyanide, N-Methyl-2-pyrrolidone, 1-Propanol, 1,3-Propanediol, 1,5-Pentanediol, Propanol, propanoic acid, propylene glycol, pyridine, tetrahydrofuran, triethylene glycol. In an embodiment, the solvent is selected from the group consisting of acetonitrile, tetrahydrofuran, acetone, ethylacetate and dichloromethane. In a preferred embodiment, the solvent is acetonitrile (CH₃CN).

The water miscible solvent can act as a ligand to alter the reaction rates of the nanoparticle precursor. The solvent can also act as an initial ‘anchor’ to allow the nanoparticle precursor to be in close proximity with the metal particles, thereby promoting the formation of the NP on the metal particle surface (FIG. 1). For example, in addition to forming transitional bonds with oxy moieties on the metal particle surface, the nanoparticle precursor can also be transitionally bonded to the metal particle surface via the solvent. This allows for an increase in the nanoparticle nucleation site on the metal particle surface and hence for a greater number of NPs attached to the metal particles. In this sense, the rate of nanoparticle formation, size, number and distribution of NPs can be altered by varying the type and amount of solvent. The inventors also believe that the solvent can reversibly passivate the surface of the metal powder such that the condensation of the nanoparticle precursor on the surface is controllable. Further, the solvent can complex with the nanoparticle precursor allowing for a stable intermediate to be formed. In this regard, the growth of the nanoparticle is controllable.

The method may further include a step of heating the mixture for a time and under conditions to convert the nanoparticle precursor to nanoparticles after the mixing step. In this regard, the mixture is subjected to a reaction condition for forming the NPs. This allows the nanoparticle precursor to convert to nanoparticles (by hydrolysis and condensation). The hydrolysis and condensation processes can occur simultaneously or sequentially.

In some embodiments, this heating step comprises hydrolysing and condensing the nanoparticle precursor in the presence of the aqueous solvent to form the nanoparticles. In another embodiment, the method further includes the step of converting the nanoparticle precursor to a nanoparticle. In another embodiment, the conversion is via a reduction process. In another embodiment, the conversion is via hydrolysis. In another embodiment, the conversion is via a polycondensation process.

This heating is performed at a temperature which is below the sintering temperature. For example, this heating can also be performed at the first temperature as stated herein for covalently binding the NP to the metal particle. By subjecting the nanoparticle precursor to a first temperature, hydrolysis and condensation of the nanoparticle precursor is induced, which form nanoparticles.

Alternatively, this heating can be performed at a temperature which is different from the first temperature and which is below the sintering temperature.

Accordingly, in an embodiment, the method of forming a composite powder includes the steps of:
ai) mixing a nanoparticle precursor with the micro-size metal particles in an aqueous solvent to form a mixture;
aii) heating the mixture for a time and under conditions to convert the nanoparticle precursor to metal oxide nanoparticles;
a) covalently bonding the metal oxide nanoparticles to surfaces of the micro-size metal particles by metal-oxygen bonds via a condensation process; and
b) stochastically positioning the metal oxide nanoparticles on the surfaces of the micro-size metal particles to form the composite powder;

wherein the heating step and covalently bonding step are performed at a first temperature.

In an embodiment, the method of forming a composite powder includes the steps of:
ai) mixing a nanoparticle precursor with the micro-size metal particles in an aqueous solvent to form a mixture;
aii) heating the mixture for a time and under conditions to convert the nanoparticle precursor to MO₂ nanoparticles;
a) covalently bonding the MO₂ nanoparticles to surfaces of the micro-size metal particles by metal-oxygen bonds via a condensation process; and
b) stochastically positioning the MO₂ nanoparticles on the surfaces of the micro-size metal particles to form the composite powder;

wherein the heating step and covalently bonding step are performed at a first temperature.

The nanoparticle precursor reacts with water in the mixture via hydrolysis and polycondensation. In some embodiments, TIP reacts with water to deposit TiO_{2,} forming isopropanol as a by-product. The composition, crystallinity and morphology of TiO₂ NPs can be influenced by the presence of additives (for example solvent), the amount of water (hydrolysis ratio), and reaction conditions.

In some embodiments, the nanoparticle precursor and water is at a volume ratio of 1: 5-150. In other embodiments, the volume ratio is 1:5, 1:10, 1:15, 1:20, 1:25, 1:50, 1:75, 1:100, 1:125, or 1:150.

The mixture can be heated for at least 10 min. Alternatively, the mixture can be heated for at least 20 min, at least 30 min, at least 40 min, at least 50 min or at least 60 min. The mixture can also be heated under reflux. In this regard, the skilled person would understand that reflux is a technique involving the condensation of vapors and the return of this condensate to the system from which it originated, and is used to supply energy to reactions over a long period of time. Ideally, this occurs at the boiling point of the solvent used. In the context of the present invention, as water is the main solvent, the mixture is heated at about 100° C. When an additional solvent is added, for example acetonitrile, the skilled person would know to refer to an azeotrope table to determine the boiling point of the solvent mixture so that the heating can occur under reflux.

In some embodiments, the time and condition is heating under reflux for at least 30 min.

The method can be performed under ambient pressure. The mild conditions for forming the composite powder is desirable for large scale production.

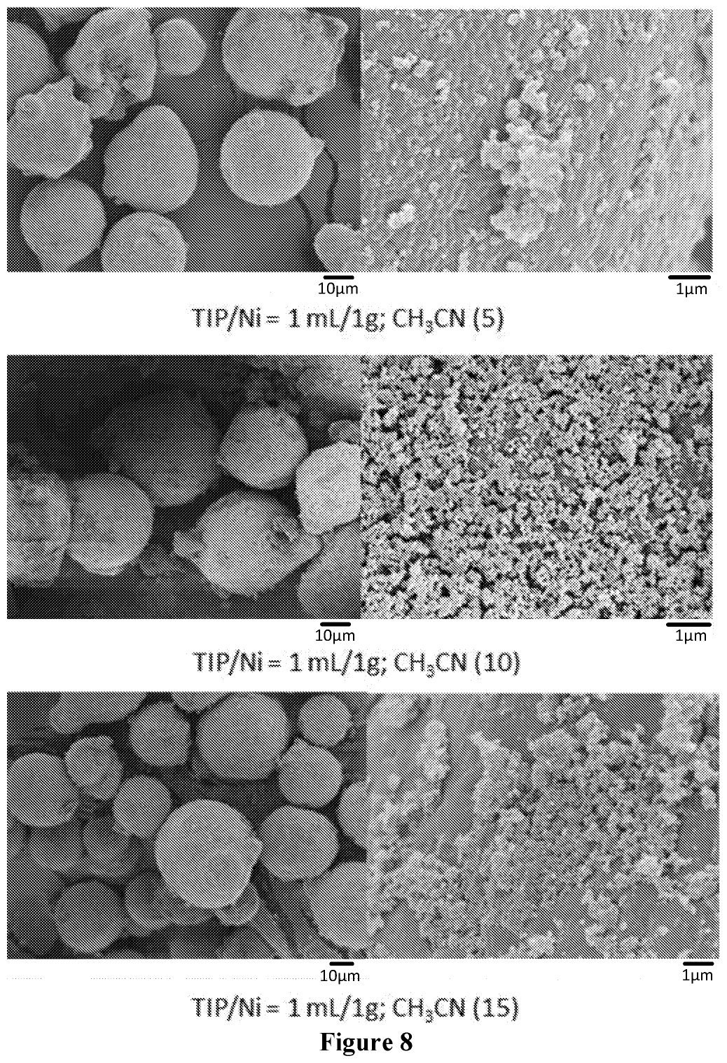

The composite powder produced using this method substantially maintains the original morphology of the micro-size metal powder. For example, if IN625 metal powder is used, the resultant MIVIC powder has a similar macroscopic morphology; i.e. comparing FIGS. 7 and 8. As mentioned above, this is advantageous for streamlining production processes as little or no modification needs to be carried out when changing the composite powder.

The inventors have also found that control over the ratio of nanoparticle precursor to metal particle can be advantageous for getting a desirable stochastic distribution of NPs on the metal particle surface. Without wanting to be bound by theory, the inventors believed that if the amount of nanoparticle precursor is too high compared to the metal particles, the dense coverage of NPs is formed on the metal particle surface, which is undesirable. Further, the distribution (for example size and shape) of the NPs is not normal, which can cause the resultant composite to be non-consistent. If the amount of nanoparticle precursor is too low compared to the metal particles, the critical amount for forming NPs may not be reached. In this sense, there may be insufficient NP initiation sites for the seed NP to form and/or insufficient nanoparticle precursor for the seed NP to grow. When the NPs are not able to attain a desirable stable size, the surface energy of the NPs may be too high, which can result in the dissolution of these NPs into a solvent soluble side product or can result in aggregation of these NPs and metal particles.

In some embodiments, the nanoparticle precursor and micro-size metal particles is at a ratio of 0.2 ml: 20 g. In this regard, for example, TIP and Ni powder is at a ratio of 0.2 ml: 20 g. The skilled person would understand that TIP has a density of 0.937 g/ml. Accordingly, in other embodiment, the nanoparticle precursor and micro-size metal powder is at a weight ratio of about 0.19:20 or about 1:105. In other embodiments, the weight ratio of the nanoparticle precursor to micro-size metal powder is about 1:40 to about 1:120, about 1:45 to about 1:110, about 1:50 to about 1:105, about 1:60 to about 1:100 or about 1:70 to about 1:90. In other embodiments, the weight ratio is about 1:40, about 1:45, about 1:50, about 1:60, about 1:70, about 1:80, about 1:90, about 1:100, about 1:105, about 1:110 or about 1:120.

In one embodiment, the nanoparticle precursor, metal powder and solvent is at a ratio of about lml: lg: 5-20 ml, or about lml: lg: 5-15 ml. In one embodiment, TIP, Inconel 625 powder and CH₃CN is at a ratio of about lml: lg: 5-15 ml. In one embodiment, TIP, Inconel 625 powder and CH₃CN is at a ratio of about lml: lg: 5, 10 and 15 ml. The skilled person would understand that CH₃CN has a density of 0.786 g/ml. Alternatively, the nanoparticle precursor, micro-size metal powder and solvent is ata weight ratio of about 0.9:1:3.9-15.7, or about 0.9:1:3.9-11.8.

In an embodiment, the nanoparticle precursor, metal powder and solvent is at a ratio of about 0.2 ml: 10 g: 0-15 ml. In one embodiment, TIP, Inconel 625 powder and CH₃CN is at a ratio of about 0.2 ml: 10 g: 0-15 ml, or about 0.2 ml: 10 g: 5-15 ml. In one embodiment, TIP, Inconel 625 powder and CH₃CN is at a ratio of about 0.2 ml: 10 g: 0, 5, 10 and 15 ml. Alternatively, the nanoparticle precursor, micro-size metal powder and solvent is at a weight ratio of about 0.19 : 10 : 0-11.8, or about 0.19: 10 : 0, 3.9, 7.9 and 11.8.

In an embodiment, the nanoparticle precursor, metal powder and solvent is at a ratio of about 0.2 ml: 20 g: 0-20 ml. In one embodiment, TIP, Inconel 625 powder and CH₃CN is at a ratio of about 0.2 ml: 20 g: 0-20 ml. In another embodiment, TIP, Inconel 625 powder and CH₃CN is at a ratio of 0.2 ml: 20 g: 0 ml. In another embodiment, TIP, Inconel 625 powder and CH₃CN is at a ratio of 0.2 ml: 20 g: 5 ml. In another embodiment, TIP, Inconel 625 powder and CH₃CN is at a ratio of 0.2 ml: 20 g: 10 ml. In another embodiment, TIP, Inconel 625 powder and CH₃CN is at a ratio of 0.2 ml: 20 g: 15 ml. In another embodiment, TIP, Inconel 625 powder and CH₃CN is at a ratio of 0.2 ml: 20 g: 20 ml. Alternatively, the nanoparticle precursor, micro-size metal powder and solvent is at a weight ratio of about 0.19:20:0, about 0.19:20:3.9, about 0.19:20:7.9, about 0.19:20:11.8, or about 0.19:20:15.7.

In one embodiment, TIP, Ti powder and CH₃CN is at a ratio of about 1 ml: 1 g: 5-20 ml. In another embodiment, TIP, Ti powder and CH₃CN is at a ratio of about 1 ml: 1 g: 5 ml. In one embodiment, TIP, Ti powder and CH₃CN is at a ratio of about 1 ml: 1 g: 10 ml. In one embodiment, TIP, Ti powder and CH₃CN is at a ratio of about 1 ml: 1 g: 15 ml. In one embodiment, TIP, Ti powder and CH₃CN is at a ratio of about 1 ml: 1 g: 20 ml.

In some embodiments, the method further includes cooling the mixture to room temperature.

By allowing the formation of nanoparticle on the metal particle surface, the composite powder may be subjected to further processing steps without loss of nanoparticles from the metal powder surface. This is highly desirable as there can be little loss of raw material, resulting in a more efficient overall process. Further, impurities and reaction by-products such as ligands, complexation agents, and/or solvents may be easily removed without complications. Nanoparticles not attached to the metal powder surface and aggregated nanoparticles may also be removed, which helps improve the homogeneity of the resultant MIVIC product.

The method can further include a step of purifying the composite powder. As mentioned above, isopropanol is produced as a side product. Further NPs can also form but are not coupled to the metal powder surface. Accordingly, the purifying step comprises separating TiO₂ nanoparticles uncoupled to the surface of the micro-size metal powder from the composite powder. The side products of the reaction can also be removed in this step. This can be performed by techniques known in the art, for example, centrifugation and/or filtration.

In one embodiment, the method further comprises the step of purifying the composite powder after the heating step. In another embodiment, the purification step comprises filtering, washing, drying or a combination thereof.

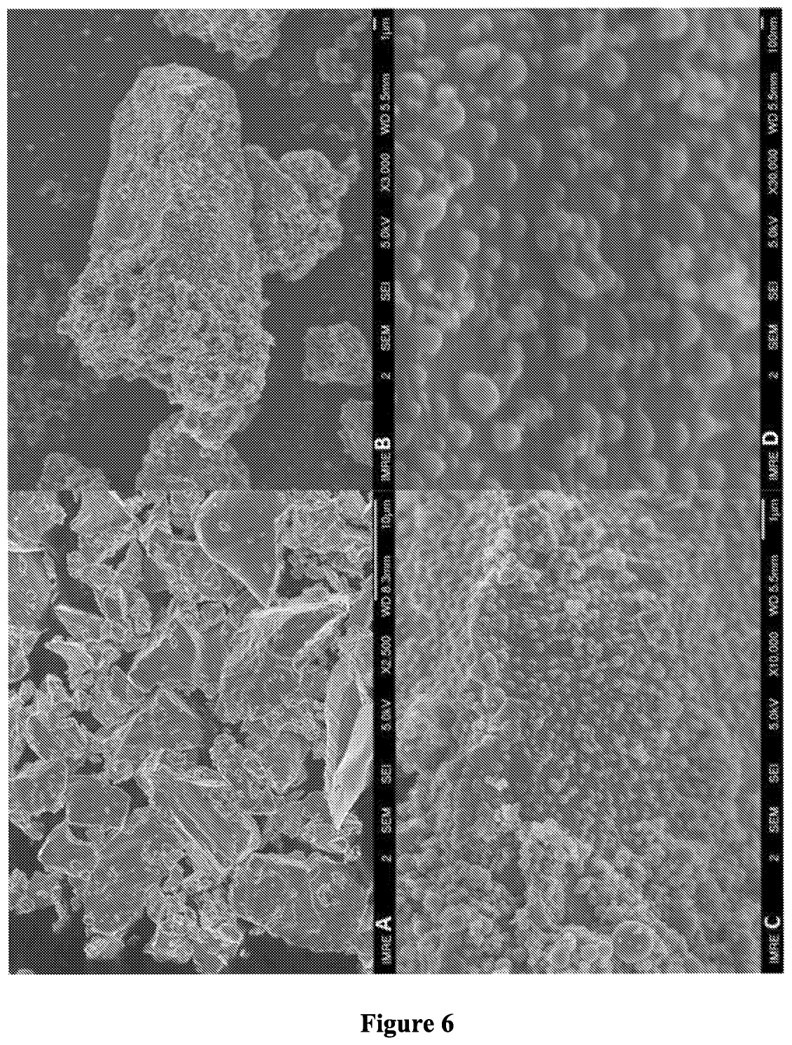

Advantageously, composite powder formed using this method of solution based soft chemistry is desirable in that a uniform dispersion of nanoparticles (NPs) with controlled morphology can be formed on a metal powder surface (FIG. 6). The NPs are coupled to the surface of the metal particles. In this regard, when the composite powder is used to form the composite, NPs are introduced into metal matrix. The NPs introduced in this way are homogenously dispersed within the composite and can avoid the problems relating to aggregations. This translates to improved material properties. Because of the reproducibility of the method, batch to batch variations can be minimized. Further, fewer steps will be required to homogenise the material during processing. This method opens up the opportunities to access to different types NPs embedded composites where the NPs can be obtained by precursor directed soft chemistry process in solution. Further, the composite powder prepared by the method of the present invention can be used in additive manufacturing, metal injection molding and metal powder spraying coating.

In another aspect, there is provided a composite obtained according to a method as defined herein. In this regard, the composite powder as disclosed herein can be sintered using known methods to form a composite. Sintering is the process of compacting and forming a solid mass of material by heat or pressure without melting it to the point of liquefaction, where the atoms in the materials diffuse across the boundaries of the particles, fusing the particles together and creating one solid piece.

The composite powder can be used to form composite. Accordingly, in another aspect, the present invention provides a composite, comprising:
a) metal oxide nanoparticles; and
b) a metal matrix selected from Ni, Inconel 625 or Ti;

wherein the metal oxide nanoparticles are coupled to the metal matrix by metal-oxygen bonds, and

wherein the metal oxide nanoparticles are stochastically positioned within the metal matrix.

In an embodiment, the composite, comprising:
a) MO₂ nanoparticles; and
b) a metal matrix selected from Ni, Inconel 625 or Ti;

wherein the MO₂ nanoparticles are coupled to the metal matrix by metal-oxygen bonds, and

wherein the MO₂ nanoparticles are stochastically positioned within the metal matrix.

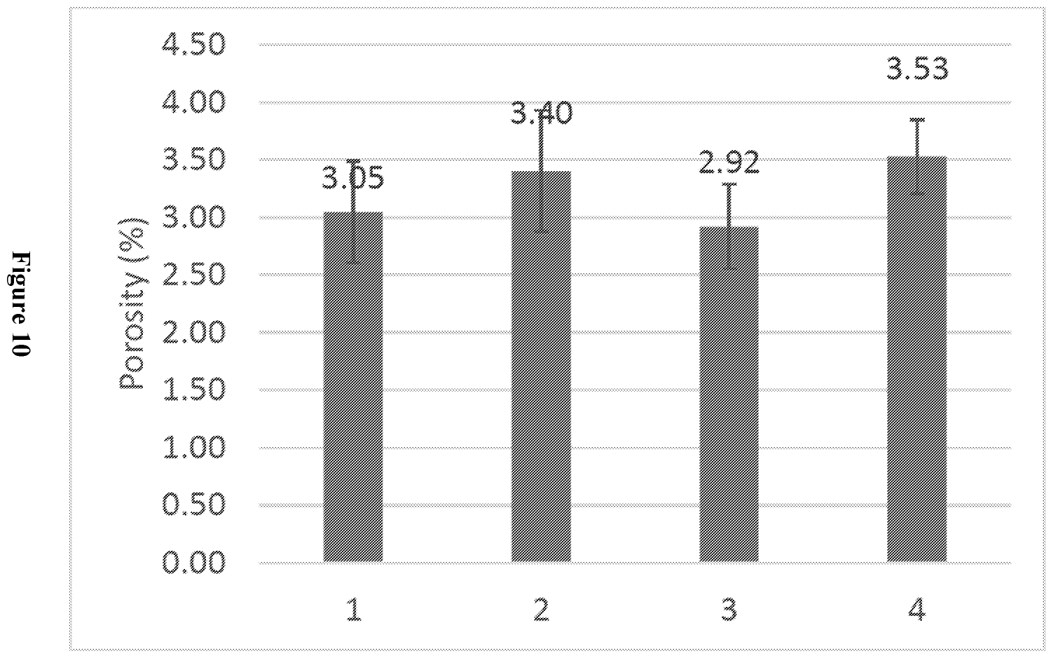

Advantageously, the formed composite has a porosity of less than about 4% (FIG. 10). The production of porosity-free composite remains a technical challenge due to the complexity of the underlying mechanism of defect formation. For example, the porosity can be due to the surface roughness of the composite powder, interfacial wetting and reactions occurring on the surface of the composite powder. A low porosity is desirable as it means that there are less defects in the composite. As highlighted above, selection of the features and parameters can favourably provide for a composite with low porosity.

In an embodiment, the composite powder can produce a composite with a porosity of less than about 4%, less than about 3.5%, less than about 3%, less than about 2.5%, less than about 2% or less than about 1.5%.

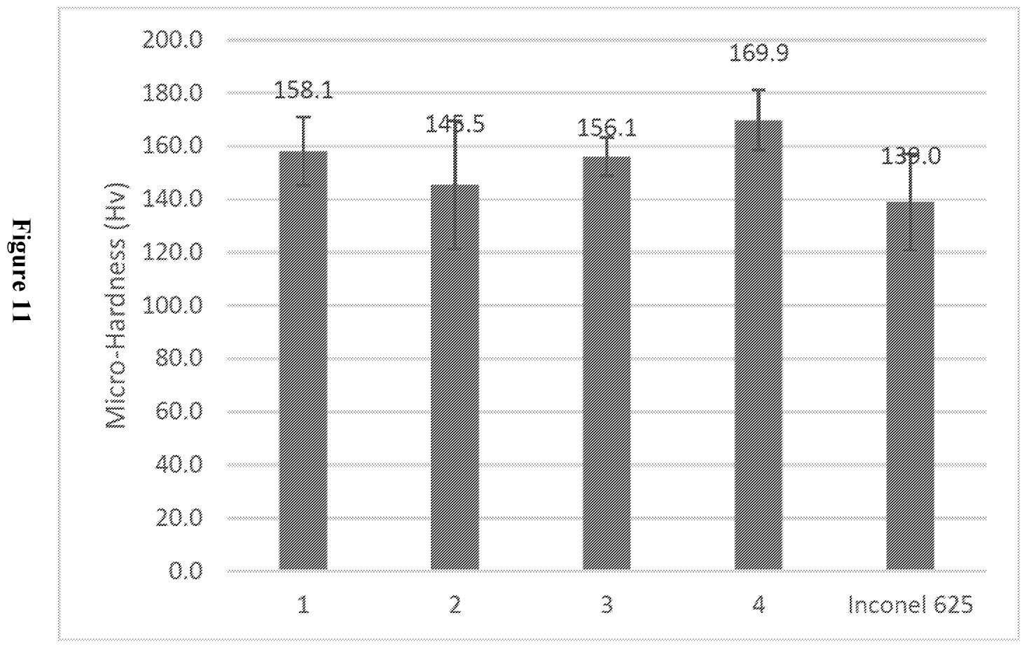

The resultant composite has an improved hardness or micro-hardness compared to a metal sample produced from a metal powder (metal matrix). FIG. 11 shows that the composite has higher hardness values compared to IN625 alone. In this regard, the composite powder can produce a composite with a hardness of at least 4% more compared to the metal matrix alone. The hardness can be at least 5% more, at least 7% more, at least 8% more, at least 10% more, at least 12% more, at least 14% more, at least 16% more, at least 18% more, at least 20% more, at least 22% more, or at least 24% more.

In another aspect, the present invention provides a method of forming a composite, includes the steps of:

a) forming a composite powder, the composite powder comprising metal oxide nanoparticles and micro-size metal particles, the micro-size particles having surfaces, wherein the metal oxide nanoparticles are coupled to the surfaces of the micro-size metal particles by metal-oxygen bonds, and wherein the metal oxide nanoparticles are stochastically positioned on the surface of the micro-size metal particles; and

b) sintering the composite powder to form the composite.

In an embodiment, the present invention provides a method of forming a composite, includes the steps of:

c) forming a composite powder, the composite powder comprising MO₂ nanoparticles and micro-size metal particles, the micro-size particles having surfaces, wherein the MO₂ nanoparticles are coupled to the surfaces of the micro-size metal particles by metal-oxygen bonds, and wherein the MO₂ nanoparticles are stochastically positioned on the surface of the micro-size metal particles; and

d) sintering the composite powder to form the composite.

In another embodiment, the method of forming a composite includes the steps of:
ai) mixing a nanoparticle precursor with the micro-size metal particles in an aqueous solvent to form a mixture;
aii) heating the mixture for a time and under conditions to convert the nanoparticle precursor to MO₂ nanoparticles;
a) covalently bonding the MO₂ nanoparticles to surfaces of the micro-size metal particles by metal-oxygen bonds via a condensation process;
b) stochastically positioning the MO₂ nanoparticles on the surfaces of the micro-size metal particles to form the composite powder; and
c) sintering the composite powder to form the composite.

Those skilled in the art will appreciate that the invention described herein in susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Certain embodiments of the invention will now be described with reference to the following examples which are intended for the purpose of illustration only and are not intended to limit the scope of the generality hereinbefore described.

### EXAMPLES

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. Preparation of TiO₂ NPs

(1) Using Ti(OⁱPr)₄ (Titanium(IV) Isopropoxide, TIP) as TiO₂ Precursor in Aqueous Medium

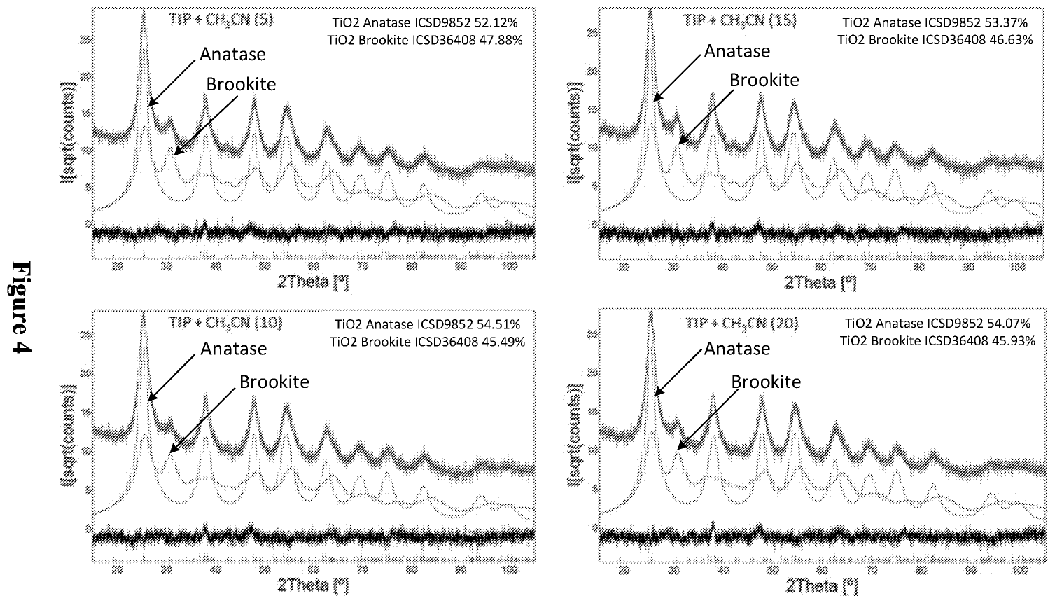

TIP (1 mL) was added in boiling water (50 mL) and the mixture was stirred vigorously at 100° C. for 30 min and then cooled at room temperature (r.t.) for 1 h. TiO₂ NPs (Ti-1) could be obtained in quantitative yield. The powder XRD spectrum (FIG. 2) shows an amorphous lump appears at low angles (<)10° . The XRD analysis reveals that Ti-1 contains 60% of anatase phase (4.0 nm) and 40% of Brookite phase (2.6 nm) when excluding the amorphous phase. The SEM images show strong aggregation of the formed NPs (FIG. 3).

(2) Preparation of TiO₂ NPs in the Presence of CH₃CN

In a general procedure TIP was mixed with CH₃CN (5, 10, 15 or 20 mL, respectively) for 30 min and then hot water (ca. 80° C.) (the total volume of CH₃CN and H₂O is 30 mL) was added and the reaction mixture was further heated under reflux for 30 min and the reaction mixture was then cooled at r.t. for 1 h. The obtained solid products were collected by centrifugation and washed with water for several times. The powder XRD analysis revealed the amount of CH₃CN does no significantly affect the morphology of the NPs which contain ca. 53% Anatase, 47% Brookite with crystallite sizes of 3.8 and 2.3 nm respectively when 5 to 20 ml of CH₃CN were added to the reaction system (FIG. 4). The SEM images of the TiO₂ NPs obtained from the reaction mixture containing CH₃CN clearly show the secondary structure of NPs is in spherical form. The reaction system with 15 mL of CH₃CN gives the best result in the terms of the homogeneity of the NP size (FIG. 5).

2. Mixing in Situ Formed TiO₂ NPs with Ti Powder

The mixture of TIP (1 mL), CH₃CN (5 mL) and Ti (1 g) powder was added to boiling water (25 mL) and the reaction mixture was refluxed for 30 min. After cooling to r.t for 1 hour, the obtained solids were washed with water several times till the white suspension of TiO₂ was removed. The obtained powders were dried in air for several days. The SEM images of Ti powder and TiO_{2/}Ti powder show that although the pure Ti powders are in irregular form (FIG. 6A), the spherical TiO₂ NPs can be attached to the surface of the Ti particles homogenously (FIG. 6B-D).

3. Mixing in Situ Formed TiO₂ NPs with Inconel 625 (IN625) Powder

The argon gas atomized Ni alloy Inconel 625 (IN625) powders are spherical as shown in FIG. 7 with particle size distributions of 15-45 μm, which composition is showed in the table below and in FIG. 7.

Chemical compositions of IN625 purchased
from LPW technology (wt %).

| Ni | Cr | Mo | Fe | Nb | Co | Cu | Mn |
|---|---|---|---|---|---|---|---|
| Balance | 20.0-23.0 | 8.0-10.0 | 5.0 | 3.15-4.15 | 1.0 | 0.50 | 0.50 |

| | | | | | | |
|---|---|---|---|---|---|---|
| Si | Al | Ti | C | Ta | P | S |
| 0.50 | 0.40 | 0.40 | 0.10 | 0.05 | 0.015 | 0.015 |

The mixtures of TIP (1 ml) mixed with IN625 (1 g) in 5, 10, or 15 mL of CH₃CN were allowed to react with H₂O respectively, and the total volume of CH₃CN and H₂O is 30 mL. The SEM images of the obtained the TiO₂/Ni powder show the spherical TiO₂ NPs can attach to the surface of Ni powders however with aggregation due to the high ratio of TIP/Ni (1 mL/1 g) (see FIG. 8).

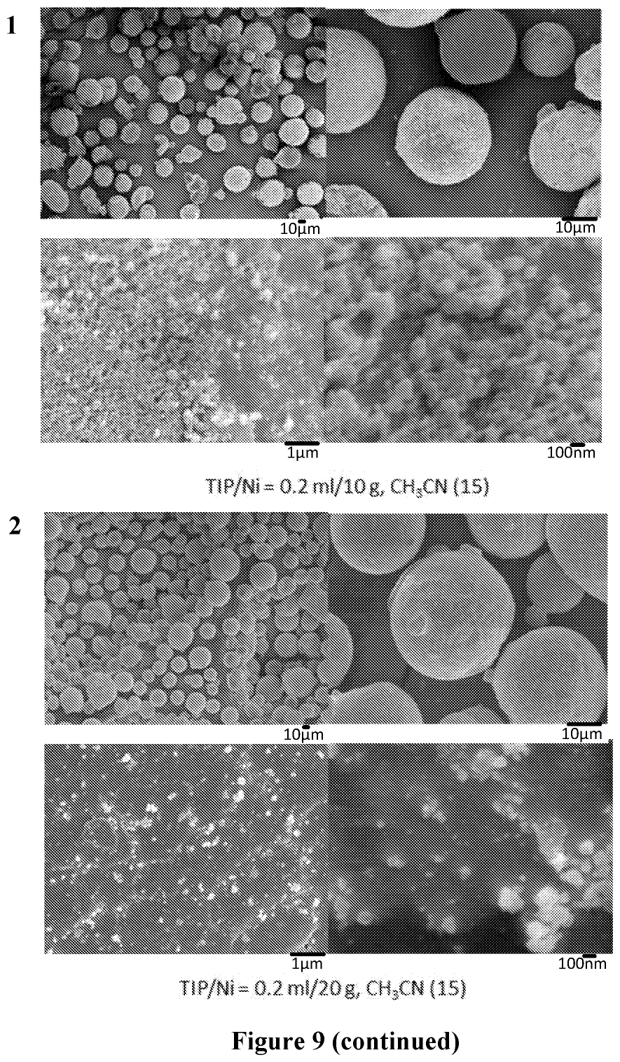

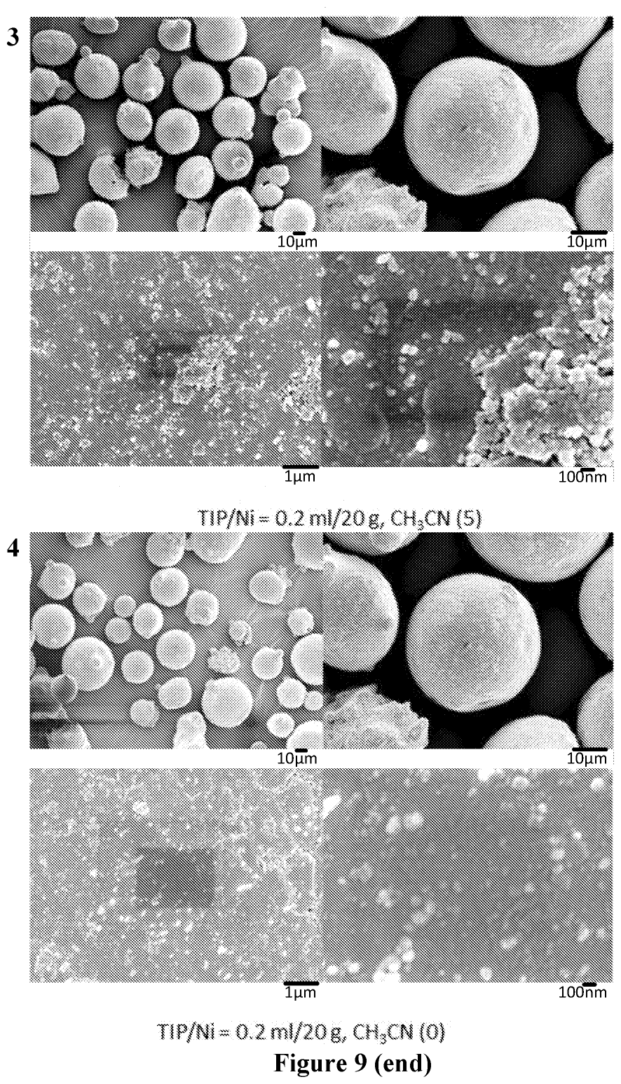

When the ratio was reduced to 0.2 mL/10 g and 0.2 mL/20 g with 15, 10 and 5 mL of CH₃CN in H₂O (the total volume of CH₃CN and H₂O is 30 mL), the aggregation is reduced. In the absence of CH₃CN, with the ratio of TIP/Ni of 0.2 mL/20 g, the distribution of the NPs is found less aggregated than those in the cases with CH₃CN (see FIG. 9). For all cases, IN625 keeps its original size and spherical shape. This is different from the composite powders obtained via ball milling method where the shape of the metal powders are milled into irregular shape.

4. Micro-Indentation Hardness Characterization and Porosity of the Composite TiO₂/Ni

Using the TiO₂/Ni MMC powders (1-4) shown in FIG. 9, NPs embedded Inconel 625 composites are prepared using sintering method. The TiO₂/Ni samples (1-4) (9.2 g for each feedstock) were mixed with PVB (0.2 g, ca. 2 wt % for each feedstock) in IPA solutions (2.5 ml for each feedstock) under ultrasound irradiation briefly. The obtained mixtures were dried in a vacuum oven at 60° C. for 2 h. The obtained solids were grounded and sieved through a 200-mesh stainless steel sieve in order to avoid the segregation of powders. The sieved powders were pressed into round pellets of ca.1.2 g in a round die-set of 1 cm in diameter under 7 tons of force for 8 min. The sintering process was carried out under argon atmosphere following procedure known in the art. The porosity of the samples is evaluated based on the Archimedes principle and the results are shown in FIG. 10. The samples 1-4 show the similar density.

The hardness of the sintered samples was measured with a BUEH-LER1 MICROMET 2103 system using a Vickers Diamond Pyramid indenter for mechanical property evaluation and comparison. The hardness was measured with a load of 1 kgf at 6 different points, which were uniformly dispersed across the sample surfaces. The hardness values were calculated as the average of the 6 points. The results are shown in FIG. 11.

Comparing with the hardness value of as received IN625 specimens (ca. 139 Hv) (comparator), all TiO₂ added samples 1-4 show improved hardness with the weight percentage of TiO₂ in the MMC derived from soft chemistry method (1-4) with only 0.5% (for 1) and 0.25% (for 2-4) of TiO₂ (calculated weight percentages). Sample 4 with the most uniform NP distribution gives the highest micro-hardness value.

1. A composite powder, comprising:
a) metal oxide nanoparticles,; and
b) micro-size metal particles, the micro-size particles having surfaces;
wherein the metal oxide nanoparticles are coupled to the surfaces of the micro-size metal particles by metal-oxygen bonds, and
wherein the metal oxide nanoparticles are stochastically positioned on the surface of the micro-size metal particles.

2. The composite of claim 1, wherein the metal oxide nanoparticles is selected from MO, MO₂, or M₂O₃ nanoparticles.

3. The composite powder of claim 1 or 2, wherein M is a tetravalent transition metal.

4. The composite powder according to any of claims 1 to 3, comprising:
a) TiO₂ nanoparticles; and
b) micro-size metal particles, the micro-size particles having surfaces;
wherein the TiO₂ nanoparticles are covalently bonded to the surfaces of the micro-size metal particles by metal-oxygen bonds, and
wherein the TiO₂ nanoparticles are stochastically positioned on the surface of the micro-size metal particles.

5. The composite powder according to any of claims 1 to 4, wherein the mean particle size ratio of nanoparticles to micro-size metal particles ranges from about 1:50 to about 1:450.

6. The composite powder according to any of claims 1 to 5, wherein the weight ratio of the nanoparticles to the micro-size metal particles ranges from about 1:150 to about 1:550.

7. The composite powder according to any of claims 1 to 6, wherein the micro-size metal particles is a pure metal powder or a metal alloy powder.

8. The composite powder according to any of claims 1 to 7, wherein the micro-size metal particles is selected from the group consisting of Ni powder, Inconel 625 powder or Ti powder.

9. The composite powder according to claim 4, wherein the TiO₂ nanoparticles has a phase structure of about 50% to about 60% anatase phase and about 40% to about 50% brookite phase.

10. The composite powder according to any of claims 1 to 9, wherein the nanoparticles have a mean particle size of about 100 nm to about 400 nm.

11. The composite powder according to any of claims 1 to 10, wherein the micro-size metal particles has a mean particle size of about 10 μm to about 80 μm.

12. A method of forming a composite powder, the composite powder comprising metal oxide nanoparticles and micro-size metal particles, the micro-size particles having surfaces, the method including the steps of:
a) covalently bonding the metal oxide nanoparticles to surfaces of the micro-size metal particles by metal-oxygen bonds; and
b) stochastically positioning the metal oxide nanoparticles on the surfaces of the micro-size metal particles to form the composite powder.

13. The method of claim 12, wherein the covalently bonding step comprises condensing the metal oxide nanoparticles on the surfaces of the micro-size metal particles to form the metal-oxygen bonds.

14. The method of claim 12 or 13, further including a step of mixing a nanoparticle precursor with the micro-size metal particles in an aqueous solvent to form a mixture prior to step (a).

15. The method of claim 14, further including a step of heating the mixture at a first temperature for a time and under conditions to convert the nanoparticle precursor to metal oxide nanoparticles after the mixing step.

16. The method of claim 15, wherein the heating step comprises hydrolysing and condensing the nanoparticle precursor in the presence of the aqueous solvent to form the metal oxide nanoparticles.

17. The method according to any of claims 14 to 16, wherein the nanoparticle precursor is Ti(IV) alkoxide.

18. The method according to any of claims 14 to 17, wherein the nanoparticle precursor is selected from the group consisting of titanium(IV) isopropoxide (TIP), titanium (IV) ethoxide, titianium(IV) butoxide, titanium(IV) propoxide and titanium(IV) tert-butoxide.

19. The method according to any of claims 14 to 18, wherein the aqueous solvent comprises a water-miscible organic solvent.

20. The method according to claim 19, wherein the water-miscible organic solvent is selected from the group consisting of acetonitrile, tetrahydrofuran, acetone, ethylacetate and dichloromethane.

21. The method according to any of claims 14 to 20, wherein the weight ratio of the nanoparticle precursor to micro-size metal powder is about 1:40 to about 1:120.

22. The method according to any of claims 15 to 21, wherein the time and condition is heating under reflux for at least 30 min.

23. The method according to any of claims 12 to 22, further including a step of purifying the composite powder after step (b).

24. The method according to claim 23, wherein the purifying step comprises separating metal oxide nanoparticles uncoupled to the surface of the micro-size metal powder from the composite powder.

25. A composite, comprising:
a) MO₂ nanoparticles; and
b) a metal matrix selected from Ni, Inconel 625 or Ti;
wherein the MO₂ nanoparticles are coupled to the metal matrix by metal-oxygen bonds, and
wherein the 2 nanoparticles are stochastically positioned within the metal matrix.
